(19) United States
(12) Patent Application Publication
(10) Pub. No.: US 2026/0254725 A1
(43) Pub. Date: Aug. 27, 2026

(54) Network Topological Graph Processing Method and Apparatus

(71) Applicants: CHINA MOBILE GOUP DESIGN INSTITUTE CO., LTD., Beijing (CN); CHINA MOBILE COMMUNICATIONS GROUP CO., LTD., Beijing (CN)

(72) Inventors: Zhigang Ding, Beijing (CN); Hongwei Lv, Beijing (CN); Zhonggui Bu, Beijing (CN); Lili Zhu, Beijing (CN); Jing Xu, Beijing (CN); Xiaoming Song, Beijing (CN)

(21) Appl. No.: 18/879,347

(22) PCT Filed: Mar. 1, 2024
(86) PCT No.: PCT/CN2024/079747

§ 371 Date: Dec. 27, 2024

(30) Foreign Application Priority Data
Mar. 1, 2023 (CN) 202310223079.3

(51) Int. Cl. H04L 41/12; G06F 11/30; H04L 41/14

(52) U.S. Cl. CPC H04L 41/12; G06F 11/3062; H04L 41/14

(57) ABSTRACT

A network topological graph processing method and apparatus. The method includes: obtaining a network topology graph by drawing according to a user's network topology drawing operation, in which the network topology drawing operation complies with a preset standard network topology expression rule; analyzing the network topological graph, and generating one or more of a power consumption detailed list, a network installation space statistics list, a device cost list, or a device cable connection relation list according to an analysis result.

### CROSS REFERENCE TO RELATED APPLICATIONS

This application is a U.S. national phase of International Application No. PCT/CN2024/079747, filed with the State Intellectual Property Office of P. R. China on Mar. 1, 2024, which is based on and claims priority to Chinese patent application No. 202310223079.3, filed on Mar. 1, 2023, the entire contents of which are incorporated herein by reference.

### TECHNICAL FIELD

The disclosure relates to the technical field of network construction, in particular to a method and apparatus for processing a network topology graph.

### BACKGROUND

Network design often starts with network topology design. Network topology can clearly express macro requirements for network construction. Then further consideration is given to the devices, cable requirements, computer room air conditioning, air conditioning, power environment requirements, etc. that are required to be configured in a project to meet a target topology. Finally, a detailed design document for the network construction project will be generated, which includes devices and material configurations required for network construction, and resource application requirements, etc.

Traditional network topology design is usually done by professionals using drawing tools to draw a logical network topology. Then, based on technical experiences, the professionals understand and manually analyze network configuration information expressed in the topology graph, and apply Excel and other spreadsheet tools to prepare a device list, a cable list, and a network investment cost list required for network planning and design in combination with other information, such as product documents and orders of network devices, and engineering and technical standards.

However, the network topology drawn by the traditional scheme only represents macroscopic characteristics of the network, and can't serve to connect various parts of the network design in series. There is a separation between the topology plan and the detailed design, and a large amount of manual conversion work is required, making it difficult to ensure efficiency and quality. In addition, the existing topology drawing tools focus more on drawing itself, which can provide the ability to draw beautiful and easily understood graphic logic, but do not support the ability to automatically convert drawn network graphics into network configuration data. The network service logic represented by graphics need to be manually analyzed. With the increase in the scale and complexity of existing network designs such as 5G networks and cloud resource pools, the methods of compiling a device list, a cable list and a network investment cost list by manually filling in Excel tables are highly inefficient, which may cause a great risk of error and has a low standard, and thus it might bring great hidden dangers to the progress and quality assurance of the engineering design of network infrastructure construction projects.

### SUMMARY

According to a first aspect of the disclosure, a method for processing a network topology graph is provided. The method includes:
obtaining a network topology graph by drawing according to a user's network topology drawing operation, wherein the network topology drawing operation complies with a preset standard network topology expression rule;
analyzing the network topology graph; and
generating one or more of a power consumption detailed list, a network installation space statistics list, a device cost list, and a device cable connection relationship list according to an analysis result.

According to a second aspect of the disclosure, a computing device is provided. The computing device includes: a processor, a memory,

is configured to perform a method for processing a network topology graph, comprising:
obtaining a network topology graph by drawing according to a user's network topology drawing operation, wherein the network topology drawing operation complies with a preset standard network topology expression rule;
analyzing the network topology graph; and
generating one or more of a power consumption detailed list, a network installation space statistics list, a device cost list, or a device cable connection relationship list according to an analysis result.

According to another aspect of the disclosure, a computer storage medium is provided. The storage medium stores at least one executable instruction, and the executable instruction causes a processor to perform operations corresponding to the method for processing a network topology graph described above.

### BRIEF DESCRIPTION OF THE DRAWINGS

Various other advantages and benefits will become clear to those skilled in the art by reading the following detailed description of the preferred implementations. The drawings are only for the purpose of illustrating the preferred implementations, and are not considered as limiting the disclosure. Moreover, the same parts are denoted by the same reference symbols throughout the drawings, in which:

FIG. 1 is a flowchart of a method for processing a network topology graph provided by an embodiment of the disclosure.

FIG. 2 is a schematic graph of an apparatus for processing a network topology graph provided by an embodiment of the disclosure.

FIG. 3 is a schematic graph of a computing device provided by an embodiment of the disclosure.

### DETAILED DESCRIPTION

Reference will now be made in detail to exemplary embodiments, examples of which are illustrated in the accompanying drawings. Although exemplary embodiments of the disclosure are shown in the drawings, it should be understood that the disclosure can be implemented in various forms and should not be limited by the embodiments set forth herein. Instead, these embodiments are provided to enable a more thorough understanding of the disclosure and to disclose the complete scope of the disclosure to those skilled in the art.

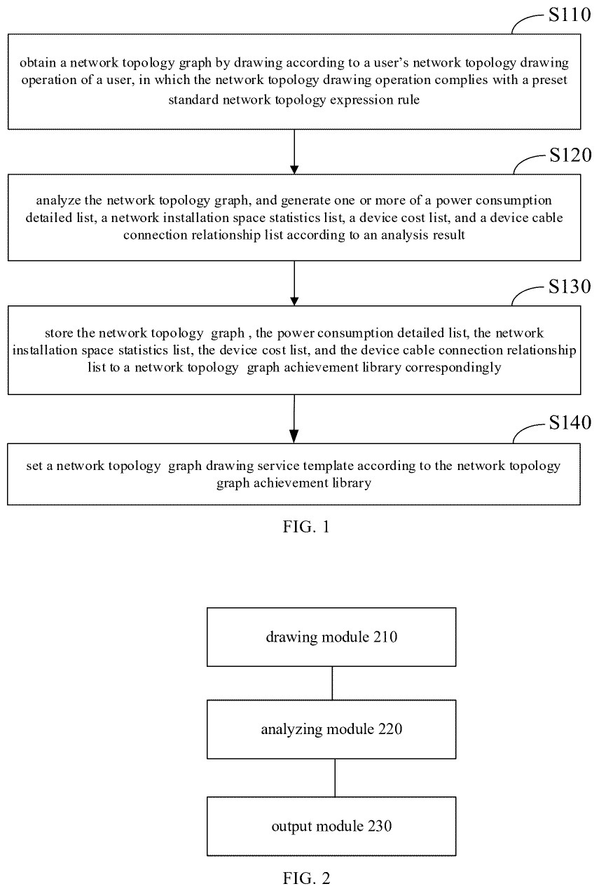

FIG. 1 is a flowchart of a method for processing a network topology graph provided by an embodiment of the disclosure. As illustrated in FIG. 1, the method includes the following steps.

At step S110, a network topology graph is obtained by drawing according to a user's network topology drawing operation, wherein the network topology drawing operation complies with a preset standard network topology expression rule.

In this step, the database for constructing user interfaces can be applied. For example, the front-end technology of user Web interface such as React can be applied, drawing tools and templates can be selected from the pre-constructed database through dragging and other operations. The network topology graph can be obtained by drawing according to the user's network topology drawing operation. In the process of drawing the network topology graph, the user's drawing behavior is verified in real time based on the preset standard network topology expression rule. A drawing that is drawn according to the preset standard network topology expression rule can be uniquely mapped into an unambiguous network topology graph. It should be noted that if the user's drawing behavior does not conform to the preset standard network topology expression rule, the user's relevant operations are prohibited with a prompt.

In an optional way, the preset standard network topology expression rule at least include: expression rules of various network elements. Each network element includes: a point element, a line element, an area element and a group element. The point element is used to express device information of a device. The line element is used to express a connection relationship between devices, in which the connection relationship between devices at least includes a cable connection. The area element is used to wrap up a point element, a line element, an area element and/or a group element to form a network topology service section in network planning and construction. The group element is used to wrap up a point element and/or a line element to express a repeated network topology structure.

In detail, the preset standard network topology expression rule defines that the network topology is consisting of four types of network topology elements, i.e., device (point) element, cable (line) element, area element and group element. The restriction algorithm of the standard network topology expression rule is provided as follows.
1) Point element is used to express device information of a device. In detail, each device element has an inherent type and can only be selected from a specific type library. Types include: switch, router, server, firewall, disk array, etc. Each device type corresponds to a fixed topology device icon.
2) Line element is used to express a cable connection relationship between devices. In detail, each cable element has an inherent type and can only be selected from a specific type library. The types in the type library include: first-level types, such as optical fiber, twisted pair, wireless, etc.; second-level types, such as optical fiber-multimode/single mode, twisted pair-class 5/class 6, etc.; and third-level types, such as 100GE/25GE, etc. Each cable type corresponds to a topology connection line style.
3) Area element can wrap up several devices (point elements), cables (line elements), area elements, group elements and other elements to express the concept of service sections in an actual network topology graph. The area element supports nesting.
4) Group element can wrap up several devices (point elements) and line elements to express repeated network structure. It should be noted that group element does not support nesting.
5) It should be noted that line element cannot exist independently, that is, both ends of any line element must be connected to devices (point elements), and cannot be connected to group elements or area elements, and only one device element can be connected to one end of a line.
6) Point elements, line elements and group elements all have a “quantity” attribute. The attribute value is a positive integer greater than or equal to 1, and the default value is 1. By modifying this attribute, multiple identical elements can be expressed by one icon. It should be noted that the quantity attribute of area elements can only be 1.
7) There are two forms of line elements, “directed” and “undirected”. In detail, when a line element (cable) is a directed line, for example, when a cable is connected from device 1 to device 2, the end of the device 1 is labelled as end A, and the end of the device 2 is labelled as end B. When in this connection relationship, it can be described as: device 1 is up connected to device 2. If the cable is an undirected line, when a line is connected from device 1 to device 2. When in this connection relationship, it can be described as: device 1 is interconnected to device 2. For device elements at both ends of a directed cable (up connected), the quantity attribute of devices at end A can be greater than 1, and the quantity attribute of devices at end B can only be 1. The quantity attribute of device elements at both ends of an undirected (interconnected) cable can only be 1.
8) Wrapping of group elements has the following rule requirement. If there is any point element in the point elements wrapped up by the group element is connected to an end B point element (device), the end B point element (device) must also be wrapped up until there is no end B point element (device) at the leaf node.

In particular, any element on the network topology graph has a customizable service type, which is input by the network topology graph drawer. For example, if the inherent type of device element 1 is server device, the drawer can input the service type: network management server. In addition, in order to give more information to elements in the network topology graph so as to realize more refined network engineering management, any element in the network topology graph can support a labeling operation, that is, the element is labeled with a custom attribute. For example, construction type: new building, or, project period: Phase I, etc. Each point element can be bound to a real device model in the existing device library, for example, a router device element is bound to a NE40E router in the device library.

This embodiment also supports the function of locking point elements in the network topology graph. When a point element is in a locked state, the point element cannot be deleted, all existing attributes cannot be modified, the group and area it is in cannot be modified, and existing cable connections cannot be modified. Other operations except the above operations can be performed normally. Attributes such as element IDs exported in the locked state will not be changed by non-locking operation. The network topology graph drawn by the user can be uniquely represented by the system as structured data for the network service topology. The data formats include but are not limited to extensible Markup Language (XML), JavaScript Object Notation (JSON) and other data formats, which supports the reverse generation of network topology graph through data. The data can be released to other system applications through an application programming interface (API) for communication construction drawing rack design, plane layout design, hardware and software integration design, etc.

At step S120, the network topology is analyzed, and one or more of a power consumption detailed list, a network installation space statistics list, a device cost list, and a device cable connection relationship list are generated according to an analysis result.

In an optional way, step S120 further includes: determining working state relationships between devices by analyzing device information of each device in the network topology graph; obtaining a standard power consumption corresponding to each device from a pre-constructed database according to the device information; and calculating an overall power consumption requirement for network planning and construction according to the standard power consumption corresponding to each device and the working state relationships between devices, and generating a power consumption detailed list according to a device type of each device.

The working state relationships between devices include at least of: a conflict working state relationship and a co-operative working state relationship.

In an optional way, the pre-constructed database at least includes: a network element library and a network device library. The method includes: storing a plurality of network elements for constituting a network topology in structure according to the pre-set standard network topology expression rule; constructing the network element library according to the plurality of network elements, in which element information of network elements at least includes: type information of network elements, description information of network elements and network icons of network elements; storing device information entries corresponding to point elements in the network elements in structure, and constructing the network device library according to the device information entries; in which each device information entry includes one or more of the following fields: service domain to which the device belongs, device type classification, manufacturer, device model, device space, device image, a configuration description, rated power consumption, maximum number of optical ports, maximum number of electrical ports, and source of information.

In detail, various network elements used to constitute the network topology are structurally stored according to the preset standard network topology expression rule. The network elements may include information such as the inherent type of device and the inherent type of cable, and descriptions and network icons corresponding to network elements. The service domains to which the devices belong in the device information entry include service domains such as network cloud, bearer network, and security. The device type classification includes: a first-level type of device types, a second-level type of device types, etc. The device space includes a cabinet size and other information.

In this embodiment, the network element library and the network device library can be flexibly called by the topology graph drawer, and the user is supported in performing individual or batch management operations on data in the network element library and the network device library, such as adding, deleting, modifying and querying.

In detail, the back-end system obtains the standard power consumption corresponding to each device and the working state relationship between devices from the pre-constructed database according to the device information corresponding to the point elements drawn in the network topology graph, and takes into account the input information such as connection relationships between relevant devices, number of connections, working state relationship, etc., and automatically counts the power consumption requirements for all the elements by means of the pre-configured algorithm, and obtains the overall power consumption requirement for network planning and construction after summing up, and outputs the power consumption detailed list according to the classification list of each device type through the pre-configured algorithm.

In an optional way, step S120 further includes: obtaining connection relationships, the number of connections of each device in the network topology graph, and relative position relationships between different devices; obtaining device size information of each device from a pre-constructed database according to the device information; and calculating a occupied space requirement for network planning and construction according to the device size information of each device, the connection relationships between devices, the number of connections, and the relative position relationships between different devices, and generating a network installation space statistics list based on a preset requirement of network planning and construction and an overall power consumption requirement of network planning and construction, in which the network installation space statistics list includes an overall physical space and a device cabinet number requirement corresponding to network planning and construction. In detail, the network installation space statistics list can obtain the standard power consumption of the device and device size information from the preset database according to the device information corresponding to the point elements drawn in the network topology graph. Considering input information such as device connection relationships, the number of connections, and relative position ranges between different devices, the power consumption and occupied space requirement of all elements are automatically counted through the pre-set algorithm, which fully considers the capacity limitation of network cabinet in device installation and deployment, the device disaster recovery requirement design, and the relationship between the maximum power consumption limitation of network cabinet and the overall power consumption requirement of network planning and construction, etc., and automatically outputs the overall physical space required by network elements and the number of cabinets required.

In an optional way, the method includes: generating a device cost list and a device cable connection relationship list required for network planning and construction according to the network topology graph.

That is, after the user finishes drawing the network topology graph, the pictures of the topology graph can be exported based on the drawings, including but not limited to a network device cost list, a device cable connection relationship list, a device power consumption requirement list, a device space requirement list and a network total price list required for network planning and construction. In detail, the device cost list required for network planning and construction can obtain unit prices of devices and cables from the pre-constructed database according to the device information corresponding to the point elements and the cable information corresponding to the line elements drawn in the drawings. The input information such as the type and quantity of relevant devices and cables is synthesized, the prices of all elements are automatically counted through the pre-configured algorithm, and the overall network cost is obtained after summation. According to the pre-configured algorithm, the price list is output according to each device type and the cable type list. The device cable connection relationship list maps the connection relationships between point elements drawn in the drawings to the connection relationships between specific devices, and the line elements connecting the point elements are mapped to specific physical cable types. Combined with other information in the network topology graph, the connection relationships between point elements in the network topology are mapped to the connection relationships between specific devices, and the line elements connecting the point elements are mapped to specific physical cable types based on the device types corresponding to the connected point elements. Combined with other information in the network topology graph, the cable schedule list with detailed information such as device information (including device type, service attribute, location and device ID) and connection information (including cable type, cable ID, the number of cables and cable label) is automatically output, so as to automatically output the device cable connection relationship list with detailed information in the following table 1.

TABLE 1
Device cable connection relationship list

| Point element (device) at end A | | | | | | | | Point element (device) at end B | | |
|---|---|---|---|---|---|---|---|---|---|---|
| device | specific | service | device | belonged | belonged | device | device | device | specific | service |
| type | device | Attribute | model | area | group | ID | label | type | device | Attribute |
| | type | | | | name | | | | type | |

| Point element (device) at end B | | | | | Connection relationship | | | |
|---|---|---|---|---|---|---|---|---|
| device | belonged | belonged | device | device | cable | cable | number | cable |
| model | area | group | ID | label | type | ID | of | label |
| | | name | | | | | cables | |

At step S130, the network topology graph, the power consumption detailed list, the network installation space statistics list, the device cost list, and the device cable connection relationship list are stored to a network topology graph achievement library correspondingly.

At step S140, a network topology graph drawing service template is set according to the network topology achievement library.

In detail, the network topology achievement library stores the complete network topology graph completed by the user and various export and presentation ways of the network topology map, and stores attribute information such as network topology graph's author, completion time, and user-defined configuration note. By setting the network topology graph drawing service template according to the network topology graph achievement library, the user can start drawing the network topology graph using the service template. This service template supports the user to perform management operations such as adding, deleting, modifying, and querying data in the library by a single piece or in batch. Some of the achievements in the library can be classified by the user itself. In addition, different application permissions for service template can be set for different users in the backend.

Using the method of the embodiment, a network topology graph is obtained by drawing according to a user's network topology drawing operation, in which the network topology drawing operation complies with a preset standard network topology expression rule. The network topology graph is analyzed. One or more of a power consumption detailed list, a network installation space statistics list, a device cost list, and a device cable connection relationship list are generated according to an analysis result. The network topology graph, the power consumption detailed list, the network installation space statistics list, the device cost list, and the device cable connection relationship list are stored to the network topology achievement library correspondingly. The network topology graph drawing service template is set according to the network topology graph achievement library. This method uses web front-end technology to draw network topology graph online. Online collaboration on topology graph design is realized through online result management, multi-user system and template sharing method. Network topology graphs are automatically parsed into structured data, so that the work quality and efficiency of network planning and construction can be improved, and the network topology can be uniquely represented in structure by setting the standard network topology expression rule in advance. It can automatically calculate the overall power consumption requirement for network planning and construction and the network installation space statistics list, which further improves the efficiency and accuracy of network planning and construction. Compared with traditional topology graph drawing tools, this method can not only complete network topology graph drawing, but also achieve automatic parsing of drawings to network service structured data, which makes it possible to automatically connect topology design with other processes of network construction planning and design work, thereby saving a lot of technical staffs' energy, and improving efficiency and quality. This method can be used through mainstream web browsers, which makes it even easier to use. Each step of this method can be implemented online, and centralized and unified maintenance and management platform architecture is constructed, which standardizes network device elements and cable icons, thereby making chart drawing more standardized. Therefore, it is easy to unify network consulting and delivery, and facilitates unified network construction service management and data standardization.

FIG. 2 is a schematic graph of an apparatus for processing network topology graph provided by an embodiment of the disclosure. As illustrated in FIG. 2, the apparatus includes: a drawing module 210, an analyzing module 220, and an output module 230.

The drawing module 210 is configured to obtain a network topology graph by drawing according to a user's network topology drawing operation, in which the network topology drawing operation complies with a preset standard network topology expression rule.

In an optional way, the preset standard network topology expression rule at least include: expression rules of various network elements. Each network element includes: a point element, a line element, an area element and a group element. The point element is used to express device information of a device. The line element is used to express a connection relationship between devices, in which the connection relationship between devices at least includes a cable connection. The area element is used to wrap up a point element, a line element, an area element and/or a group element to form a network topology service section in network planning and construction. The group element is used to wrap up a point element and/or a line element to express a repeated network topology structure.

The analyzing module 220 is configured to analyze the network topology graph.

In an optional way, the pre-constructed database at least includes: a network element library and a network device library. The apparatus includes: a database constructing module. The database constructing module is configured to store a plurality of network elements for constituting a network topology in structure according to the pre-set standard network topology expression rule; construct the network element library according to the plurality of network elements, in which element information of network elements at least includes: type information of network elements, description information of network elements and network icons of network elements; structurally store device information entries corresponding to point elements in the network elements, and construct the network device library according to the device information entries; in which each device information entry includes one or more of the following fields: service domain to which the device belongs, device type, manufacturer, device model, device space, device image, configuration description, rated power consumption, maximum number of optical ports, maximum number of electrical ports, and data source.

The output module 230 is configured to generate one or more of a power consumption detailed list, a network installation space statistics list, a device cost list, and a device cable connection relationship list according to an analysis result.

In an optional way, the output module 230 is configured to: store the network topology graph, the power consumption detailed list, the network installation space statistics list, the device cost list, and the device cable connection relationship list to a network topology graph achievement library correspondingly; and set a network topology drawing service template according to the network topology graph achievement library.

In an optional way, the output module 230 is configured to: determining working state relationships between devices by analyzing device information of each device in the network topology graph; obtaining a standard power consumption corresponding to each device from a pre-constructed database according to the device information; and calculating an overall power consumption requirement for network planning and construction according to the standard power consumption corresponding to each device and the working state relationships between devices, and generating a power consumption detailed list according to the device type of each device.

In an optional way, the working state relationship between devices at least includes a conflict working state relationship and a co-operative working state relationship.

In an optional way, the output module 230 is configured to: obtain connection relationships, the number of connections of each device in the network topology graph, and relative position relationships between different devices in the network topology; obtain device size information of each device from a pre-constructed database according to the device information; and calculate a occupied space requirement for network planning and construction according to the device size information of each device, the connection relationships between devices, the number of connections, and the relative position relationships between different devices, and generate a network installation space statistics list based on a preset requirement of network planning and construction and an overall power consumption requirement of network planning and construction, in which the network installation space statistics list includes an overall physical space and a device cabinet number requirement corresponding to network planning and construction.

In an optional way, the output module 230 is configured to: generate a device cost list and a device cable connection relationship list required for network planning and construction according to the network topology graph.

In an optional way, the output module 230 is configured to: store the network topology graph, the power consumption detailed list, the network installation space statistics list, the device cost list, and the device cable connection relationship list to a network topology achievement library correspondingly; and set a network topology graph drawing service template according to the network topology achievement library.

Using the apparatus of this embodiment, a network topology graph is obtained by drawing according to a user's network topology drawing operation, in which the network topology drawing operation complies with a preset standard network topology expression rule. The network topology graph is analyzed, and a power consumption detailed list, a network installation space statistics list, a device cost list, and a device cable connection relationship list are generated according to an analysis result. The network topology, the power consumption detailed list, the network installation space statistics list, the device cost list, and the device cable connection relationship list are stored to a network topology achievement library correspondingly. A network topology graph drawing service template is set according to the network topology graph achievement library. This apparatus uses web front-end technology to draw network topology graph online. Online collaboration on topology graph design is realized through online result management, multi-user system and template sharing method. Network topology graphs are automatically parsed into structured data, so that the work quality and efficiency of network planning and construction can be improved, and the network topology can be uniquely represented in structure by setting the standard network topology expression rule in advance. It can automatically calculate the overall power consumption requirement for network planning and construction and the network installation space statistics list, which further improves the efficiency and accuracy of network planning and construction.

The embodiment of the disclosure provides a non-volatile computer storage medium. The computer storage medium stores at least one executable instruction, and the computer executable instruction is executed to implement the method for processing a network topology graph in any of the above method embodiments.

The executable instruction may be specifically used to cause a processor to:
obtain a network topology graph by drawing according to a user's network topology drawing operation, in which the network topology drawing operation complies with a preset standard network topology expression rule;
analyze the network topology graph; and
generate one or more of a power consumption detailed list, a network installation space statistics list, a device cost list, and a device cable connection relationship list according to an analysis result.

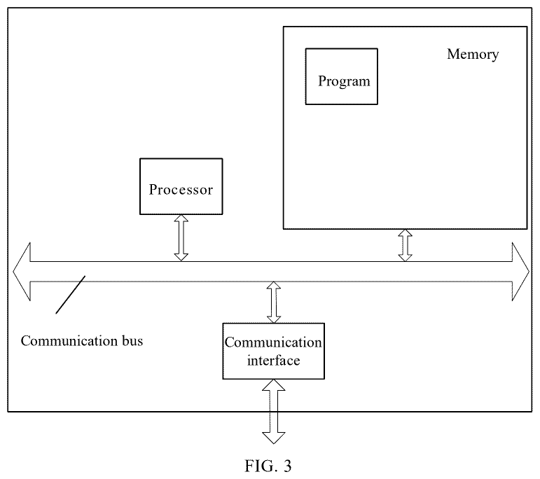

FIG. 3 is a schematic graph of a computing device of an embodiment of the disclosure, and the specific implementation of the disclosure does not limit the specific implementation of the computing device.

As shown in FIG. 3, the computing device may include:
a processor, a communication interface, a memory, and a communication bus.

The processor, the communication interface and the memory communicate with each other through the communication bus. The communication interface is used for communicating with network elements of other devices, such as clients, or other servers. The processor is used for executing the program, and specifically executing the related steps in the embodiments of the method for processing a network topology graph.

In detail, the program may include a program code, which includes computer operation instructions.

The processor may be a central processing unit (CPU), or an application specific integrated circuit (ASIC), or one or more integrated circuits configured to implement the embodiments of the disclosure. One or more processors included in the server can be the same type of processors, such as one or more CPU, or different types of processors, such as one or more CPUs and one or more ASICs.

The memory is used for storing programs. The memory may include a high-speed random-access memory (RAM), and a non-volatile memory, such as at least one disk memory.

The program may be specifically used to cause a processor to:
obtain a network topology graph by drawing according to a user's network topology drawing operation, in which the network topology drawing operation complies with a preset standard network topology expression rule;
analyze the network topology graph; and
generate one or more of a power consumption detailed list, a network installation space statistics list, a device cost list, and a device cable connection relationship list according to an analysis result.

The algorithms or displays provided herein are not inherently related to any particular computer, virtual system or other device. Various general-purpose systems may also be used with the teachings based herein. According to the above description, the structure required to construct this kind of system is obvious. In addition, the embodiment of the disclosure is not specific to any specific programming language. It should be understood that the contents of the disclosure described herein can be realized by various programming languages, and the description of specific languages above is to disclose the best implementation of the disclosure.

In the specification provided herein, numerous specific details are set forth. However, it is understood that embodiments of the disclosure may be practiced without these specific details. In some embodiments, well-known methods, structures and techniques have not been shown in detail to avoid obscuring the understanding of this specification.

Similarly, it should be understood that in order to simplify the disclosure and help to understand one or more of various inventive aspects, in the above description of the exemplary embodiments of the disclosure, several features of the embodiments of the disclosure are sometimes grouped together into a single embodiment, figure or description thereof. However, the disclosed method should not be interpreted as reflecting the intention that the claimed disclosure requires more features than those explicitly recited in each claim. Rather, as reflected in the following claims, the inventive aspects lie in less than all features of a single embodiment disclosed previously. Therefore, the claims following the specific implementations are hereby expressly incorporated into this specific implementation, in which each claim stands as a separate embodiment of this disclosure.

Those skilled in the art understand that the modules in the device in the embodiment can be adaptively changed and set in one or more devices different from this embodiment. The modules, units or assembles in the embodiment can be combined into one module, unit or assemble, and they can also be divided into a plurality of sub-modules, sub-units or sub-assemblies. Except that at least some of such features and/or processes or units are mutually exclusive, all features disclosed in this specification (including accompanying claims, abstract and drawings) can be combined all processes or units of any method or device so disclosed in any combination. Unless explicitly stated otherwise, each feature disclosed in this specification (including the accompanying claims, abstract and drawings) may be replaced by alternative features that serve the same, equivalent or similar purpose.

Furthermore, those skilled in the art understand that although some embodiments herein include some features but not others included in other embodiments, the combination of features of different embodiments is meant to be within the scope of this disclosure and form different embodiments. For example, in the following claims, any one of the claimed embodiments can be used in any combination.

The various component embodiments of the disclosure may be implemented in hardware, in one or more software modules running on the processor, or in a combination thereof. It should be understood by those skilled in the art that a microprocessor or a digital signal processor (DSP) can be used in practice to realize some or all functions of some or all components according to the embodiments of the disclosure. The disclosure can also be implemented as a device or device program (e.g., a computer program and a computer program product) for performing part or all of the methods described herein. Such a program for implementing the disclosure may be stored on a computer-readable medium, or may be in the form of one or more signals. Such a signal can be downloaded from an Internet website, or provided on a carrier signal, or provided in any other form.

It should be noted that the above-mentioned embodiments illustrate the disclosure rather than limit it, and those skilled in the art can design alternative embodiments without departing from the scope of the appended claims. In the claims, any reference signs placed between parentheses shall not be constructed as limitations on the claims. The term “comprise” does not exclude the presence of elements or steps not listed in the claims. The term “a” or “an” before an element does not exclude the presence of a plurality of such elements. The disclosure can be realized by means of hardware comprising several different elements and by means of a suitably programmed computer. In the unit claim enumerating several devices, several of these devices can be embodied by the same item of hardware. The use of terms “first”, “second”, and “third” does not indicate any order. These terms can be interpreted as names. Unless otherwise specified, the steps in the above-mentioned embodiments should not be understood as limiting the execution order.

1. A method for processing a network topology graph, comprising:
obtaining a network topology graph by drawing according to a user's network topology drawing operation, wherein the network topology drawing operation complies with a preset standard network topology expression rule;
analyzing the network topology graph; and
generating one or more of a power consumption detailed list, a network installation space statistics list, a device cost list, or a device cable connection relationship list according to an analysis result.

2. The method of claim 1, wherein analyzing the network topology, and generating one or more of the power consumption detailed list, the network installation space statistics list, the device cost list, and the device cable connection relationship list according to the analysis result, comprise:
determining working state relationships between devices by analyzing device information of each device in the network topology graph;
obtaining a standard power consumption corresponding to each device from a pre-constructed database according to the device information; and
calculating an overall power consumption requirement for network planning and construction according to the standard power consumption corresponding to each device and the working state relationships between devices, and generating the power consumption detailed list according to a device type of each device.

3. The method of claim 1, wherein analyzing the network topology graph, and generating one or more of the power consumption detailed list, the network installation space statistics list, the device cost list, and the device cable connection relationship list according to the analysis result, comprise:
obtaining device information, connection relationships, a number of connections of devices, and relative position relationships between different devices in the network topology graph;
obtaining device size information of each device from a pre-constructed database according to the device information; and
calculating a occupied space requirement for network planning and construction according to the device size information of each device, the connection relationships between devices, the number of connections, and the relative position relationships between different devices, and generating the network installation space statistics list based on a preset requirement for the network planning and construction and an overall power consumption requirement for the network planning and construction, wherein the network installation space statistics list comprises an overall physical space and a quantity demand of device cabinets corresponding to the network planning and construction.

4. The method of claim 1, wherein the preset standard network topology expression rule at least comprises: expression rules of network elements, and the network elements comprise: a point element, a line element, an area element and a group element;
wherein the point element is used to express device information of a device;
the line element is used to express a connection relationship between devices, wherein the connection relationship between devices at least comprises a cable connection;
the area element is used to wrap up at least one of the point element, the line element, the area element or the group element to form a network topology service section in network planning and construction; and
the group element is used to wrap up at least one of the point element or the line element to express a repeated network topology structure.

5. The method of claim 2 wherein the pre-constructed database at least comprises a network element library and a network device library.

6. The method of claim 5, further comprising:
structurally storing a plurality of network elements for constituting the network topology graph according to the preset standard network topology expression rule;
constructing the network element library according to the plurality of network elements, wherein element information of each network element stored in the network element library at least comprises: type information of the network element, description information of the network element and a network icon of the network element; and
structurally storing device information entries corresponding to point elements in the network elements, and constructing the network device library according to the device information entries;
wherein each device information entry of a device comprises one or more of following fields: a service domain to which the device belongs, a device type classification, a manufacturer, a device model, a device space, a device image, configuration description, a rated power consumption, a maximum number of optical ports, a maximum number of electrical ports, and a source of information.

7. The method of claim 2, wherein the working state relationship between devices at least comprises a conflict working state relationship and a cooperative working state relationship.

8. (canceled)

9. A computing device comprising:
a processor,
a memory,
is configured to perform a method for processing a network topology graph, comprising:
obtaining a network topology graph by drawing according to a user's network topology drawing operation, wherein the network topology drawing operation complies with a preset standard network topology expression rule;
analyzing the network topology graph; and
generating one or more of a power consumption detailed list, a network installation space statistics list, a device cost list, or a device cable connection relationship list according to an analysis result.

10. A non-transitory computer storage medium, wherein the storage medium stores at least one executable instruction, and the executable instruction causes a processor to perform operations corresponding to the method for processing a network topology graph, comprising:
obtaining a network topology graph by drawing according to a user's network topology drawing operation, wherein the network topology drawing operation complies with a preset standard network topology expression rule;
analyzing the network topology graph; and
generating one or more of a power consumption detailed list, a network installation space statistics list, a device cost list, or a device cable connection relationship list according to an analysis result.

11. The method of claim 3, wherein the pre-constructed database at least comprises a network element library and a network device library.

12. The method of claim 11, further comprising:
structurally storing a plurality of network elements for constituting the network topology graph according to the preset standard network topology expression rule;
constructing the network element library according to the plurality of network elements, wherein element information of each network element stored in the network element library at least comprises: type information of the network element, description information of the network element and a network icon of the network element; and
structurally storing device information entries corresponding to point elements in the network elements, and constructing the network device library according to the device information entries;
wherein each device information entry of a device comprises one or more of following fields: a service domain to which the device belongs, a device type classification, a manufacturer, a device model, a device space, a device image, configuration description, a rated power consumption, a maximum number of optical ports, a maximum number of electrical ports, and a source of information.

13. The method of claim 11 wherein the working state relationship between devices at least comprises a conflict working state relationship and a cooperative working state relationship.

14. The computing device of claim 9, wherein analyzing the network topology, and generating one or more of the power consumption detailed list, the network installation space statistics list, the device cost list, and the device cable connection relationship list according to the analysis result, comprise:
determining working state relationships between devices by analyzing device information of each device in the network topology graph;
obtaining a standard power consumption corresponding to each device from a pre-constructed database according to the device information; and
calculating an overall power consumption requirement for network planning and construction according to the standard power consumption corresponding to each device and the working state relationships between devices, and generating the power consumption detailed list according to a device type of each device.

15. The computing device of claim 9, wherein analyzing the network topology graph, and generating one or more of the power consumption detailed list, the network installation space statistics list, the device cost list, and the device cable connection relationship list according to the analysis result, comprise:
obtaining device information, connection relationships, a number of connections of devices, and relative position relationships between different devices in the network topology graph;
obtaining device size information of each device from a pre-constructed database according to the device information; and
calculating a occupied space requirement for network planning and construction according to the device size information of each device, the connection relationships between devices, the number of connections, and the relative position relationships between different devices, and generating the network installation space statistics list based on a preset requirement for the network planning and construction and an overall power consumption requirement for the network planning and construction, wherein the network installation space statistics list comprises an overall physical space and a quantity demand of device cabinets corresponding to the network planning and construction.

16. The computing device of claim 9, wherein the preset standard network topology expression rule at least comprises: expression rules of network elements, and the network elements comprise: a point element, a line element, an area element and a group element;
wherein the point element is used to express device information of a device;
the line element is used to express a connection relationship between devices, wherein the connection relationship between devices at least comprises a cable connection;
the area element is used to wrap up at least one or more of the point element, the line element, the area element or the group element to form a network topology service section in network planning and construction; and
the group element is used to wrap up at least one or more of the point element or the line element to express a repeated network topology structure.

17. The computing device of claim 14 wherein the pre-constructed database at least comprises a network element library and a network device library.

18. The computing device of claim 15, wherein the pre-constructed database at least comprises a network element library and a network device library.

19. The computing device of claim 17, further comprising:
structurally storing a plurality of network elements for constituting the network topology graph according to the preset standard network topology expression rule;
constructing the network element library according to the plurality of network elements, wherein element information of each network element stored in the network element library at least comprises: type information of the network element, description information of the network element and a network icon of the network element; and
structurally storing device information entries corresponding to point elements in the network elements, and constructing the network device library according to the device information entries;
wherein each device information entry of a device comprises one or more of following fields: a service domain to which the device belongs, a device type classification, a manufacturer, a device model, a device space, a device image, configuration description, a rated power consumption, a maximum number of optical ports, a maximum number of electrical ports, and a source of information.

20. The computing device of claim 14, wherein the working state relationship between devices at least comprises a conflict working state relationship and a cooperative working state relationship.

21. The non-transitory computer storage medium of claim 10, wherein analyzing the network topology, and generating one or more of the power consumption detailed list, the network installation space statistics list, the device cost list, and the device cable connection relationship list according to the analysis result, comprise:
determining working state relationships between devices by analyzing device information of each device in the network topology graph;
obtaining a standard power consumption corresponding to each device from a pre-constructed database according to the device information; and
calculating an overall power consumption requirement for network planning and construction according to the standard power consumption corresponding to each device and the working state relationships between devices, and generating the power consumption detailed list according to a device type of each device.
